(19) United States
(12) Patent Application Publication
(10) Pub. No.: US 2015/0293974 A1
(43) Pub. Date: Oct. 15, 2015

(54) Dynamic Partitioning of Streaming Data

(71) Applicant: David Loo, San Diego, CA (US)

(72) Inventor: David Loo, San Diego, CA (US)

(21) Appl. No.: 14/249,567

(22) Filed: Apr. 10, 2014

(51) Int. Cl. G06F 17/30

(52) U.S. Cl. CPC G06F 17/30516; G06F 17/30144; G06F 17/30864

(57) ABSTRACT

A real time data analysis and data filtering system for managing streaming data is presented. The method breaks a stream of data into a set of queues that are themselves streaming data but that are handled separately by unique processing steps. The queues are dynamically created on an as needed basis based on inspection of the data. In this manner the speed and efficiency of parallel processing is applied to serially streaming data. A method of filtering the data to present the new streaming data queues is also described. The method makes use of keys that are used to filter the data stream into individual queues. In another embodiment a pre-processing step includes creation of keys and insertion of keys into the streaming data to enable subsequent data mining to be accomplished on a less powerful computing device.

### CROSS-REFERENCE TO RELATED APPLICATIONS

Not Applicable

### BACKGROUND OF THE INVENTION

1. Technical Field

The present invention relates to systems and processes for handling streaming data.

2. Related Background Art

This is the era of big data. Very large data sets that change continuously are more and more common as sensors and data systems become more ubiquitous. Data streams may originate from varied sources. Communications streams such as cellular data or electronic mail communications, market systems such as transaction flows from both retail markets and stock exchanges and scientific measurements and sensor data all produce streams of data that in many instances must be handled as they are created or received. Analysis of data from these streams was initially through storing these large data sets in data warehouses and mining them using batch processing. However the total amount of data and speed with which it is received is now exaggerated by widespread cloud applications and service which require means to handle the data in real time. In market data for example, the number of transactions has grown with increased commerce and worldwide stock transactions taking place on a millisecond time scale storage. Batch processing is no longer a viable option. The data must be analyzed to support automated decisions and actions must be taken as the data streams in. There have been several instances over the past few years of flash crashes where erroneous market orders were allowed to proceed indicating there is still a need for faster and more robust methods for analysis of data streams. Current methods and research into managing streaming data largely focuses on finding patterns in data streams and clustering of data streams such that actions may be taken on particular patterns or that the data streams may be partitioned into groups that may be handled similarly. Handling typically means taking some action with respect to the data stream. Handling includes manipulation of the data stream through storage or deletion or initiating a programmed action when a particular data set is encountered. Existing methods require that every element within the data stream be examined to match groups of patterns or a particular pattern. However there are many instances where the data stream may include particular keys that can be used to trigger actions and manipulation of the data stream without the need to look at every data element. Furthermore current data processors range from super computers to handheld devices where the need for managing data streams can occur on the entire range of devices. There is a need for a process that partitions the data processing steps such that the computing intensive steps take place on a powerful processor thus enabling the data streams to be further managed on the smallest of processors.

There is a need for new methods to handle data streams without examining every element. There is also a need that makes use of keys within the data stream or generated for the data stream that then allows for efficient partitioning and clustering of the data for real-time selective processing.

### DISCLOSURE OF THE INVENTION

A system and process is described that addresses deficiencies in prior art methods of handling data streams. The method includes a new process for partitioning data such that a single stream of data may then be handled in a set of parallel processes. In one embodiment a data stream is examined for a set of pre-selected keys and then partitioned according to the presence or absence of the pre-selected keys. In another embodiment the partitioning results in the creation of clusters from the data stream. In another embodiment presence of certain clusters from a filtered data stream results in the execution of pre-selected programmed processes. In another embodiment the data is partitioned into clusters with at least one cluster being discarded resulting in a simplified data stream. In another embodiment the pre-selected process is storing a data stream for later processing. In another embodiment the elements within groups of data in a data stream are examined for a pre-selected pattern and when a pattern is seen one or more additional keys are inserted into the data such that the data can be subsequently filtered on the basis of presence or absence of the newly inserted key without the need to scan all of the data elements or used as parameters in subsequent execution of programmed processes.

The data processing may be accomplished on a variety of computing devices ranging from super computers to portable cell phones and tablets. In one embodiment the processing is split such that the data is first processed on a high speed computer or server to create a data stream that includes keys that can then easily be filtered on less powerful computing devices. In another embodiment partitioning into parallel and independent processes enables dynamic scalability by adding more computing devices on-demand

### BRIEF DESCRIPTION OF THE DRAWINGS

FIG. 1A is a block diagram showing system where the invention may be practiced.

FIG. 1B is a second block diagram of a system where the invention may be practiced.

FIG. 2 is a block diagram of a system including prior art.

FIG. 3 shows a block diagram of a first embodiment of the invention applied to data streams having individual keys per resulting queue.

FIG. 4A shows a flow chart for embodiments of the invention.

FIG. 4B shows a second flow chart embodiment of the invention.

FIG. 5 shows an embodiment where multiple keys may appear in data stream groupings.

FIG. 6 shows another embodiment further including a key insertion step.

### MODES FOR CARRYING OUT THE INVENTION

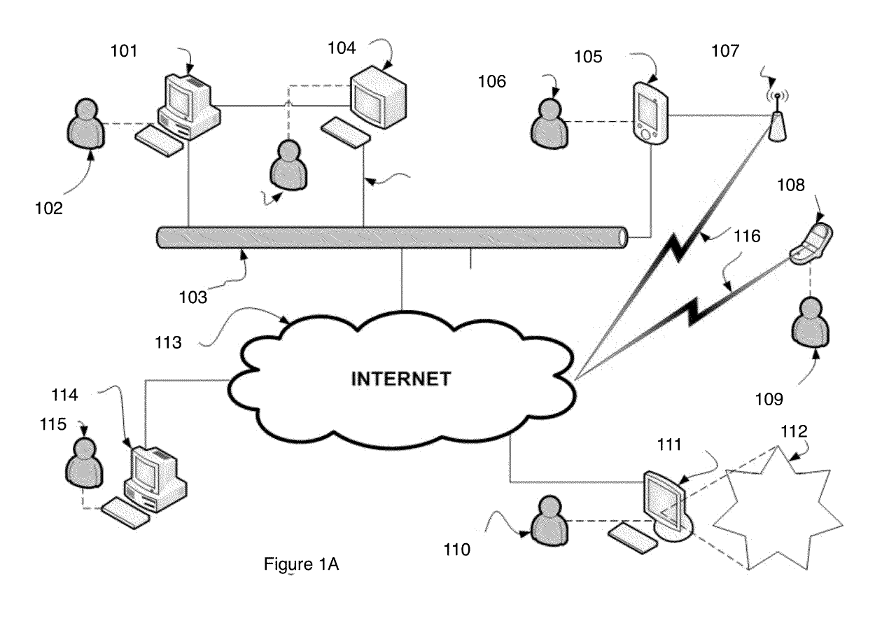

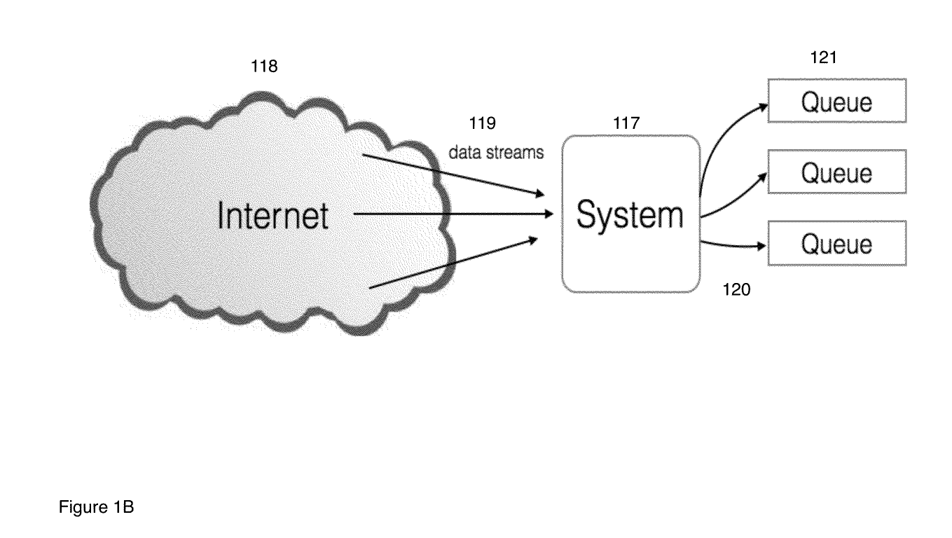

Referring to FIG. 1A exemplary systems in which the present invention may be used are shown. The invention may be practiced on a variety of types of computing devices 101, 104, 105, 108, 111, 114 interconnected by a local network 103, over the Internet 113 and through cellular networks 116. In practice there may be thousands or even millions of interconnected devices. Interconnection may be through wired or wireless means. Data is shared amongst the various users, 102, 106, 109, 110, and 115 through their interconnected computing devices. Data may be in practically any form, both binary and human readable. Non-limiting exemplary data includes audio, video, images, communication files and text files. Data may be generated by a single user 110 who is operating a server 111 that includes a program 112 to stream data to either a single other user or to multiple users through the internet. The data may also be generated by a plurality of users who are simultaneously generating data file and sending the data file to one another through a server or directly to another user. The users of the invention can be any of the users shown. Although shown as just a handful of users in the figure, there may be literally millions of users generating and receiving data and using embodiments of the invention to manage the data sent and received. In one embodiment the invention may be part of a data analysis program running on a personal computer 101, 104, 114, or a data analysis system running on a tablet computer 105 or a cellular phone 108 or a server 111. In one embodiment the invention is a “central” aggregator of streaming event data. Any of the device types shown may act as a central aggregator of a received stream of data. The device incorporating the invention has the ability to “correlate” multiple “keys” when handling the input stream. The data is filtered into multiple queues that once filtered operate in parallel. The parallel operation may be on a single device type with multiple processes or on multiple devices. In a preferred embodiment shown in FIG. 1B, a Computer system 117 receives multiple streams of data 119 from the Internet 118 and filters 120 those streams into queues. The system 117 may be any of the devices as shown in FIG. 1A. The streams are filtered based upon pre-selected keys. In another embodiment new keys may be generated as data is received and filtered. The use of keys enables separation in to data queues without the need for analysis of every data word received.

The data stream may be the server receiving data from a plurality of users and devices or the server may be the intermediary in receiving and transmitting data between a plurality of users. In one embodiment the server is a mail server. In another embodiment the server is a media server that streams digital content to a plurality of users. In one embodiment the invention is used on an incoming data stream. In another embodiment the invention is applied to an outgoing data stream.

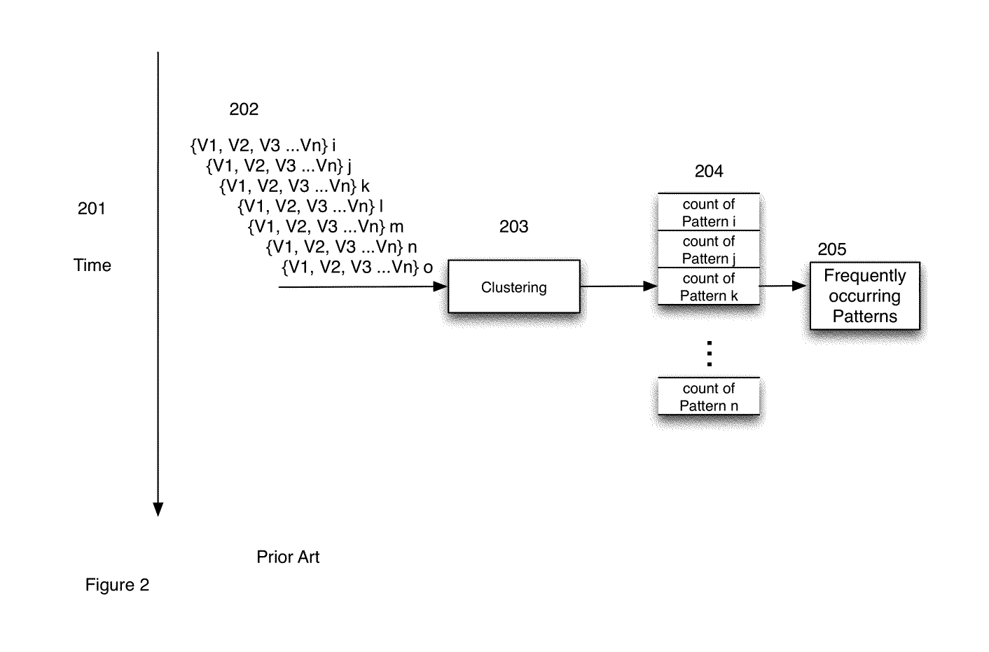

Prior art means for the handling of data streams are shown in FIG. 2. The block diagram represents passage of time 201 as a data stream 202 is received by a processor, analyzed sequentially, and counts of frequently occurring patterns are tabulated 204. The data is typically divided into data items, here labeled i, j, k, etc. and there are multiple data elements within each data item, here represented by V1, V2, etc. The data streams may represent communications between users such as voice, text message or other electronic communication, or may represent data from sensors where blocks of data are received over time and the data elements represent data from multiple sensors. The analysis/clustering step sequentially examines the data elements within each data item searching for either frequently occurring patterns of data elements or for predetermined patterns or elements. Since the data stream 202 is of indeterminate length and is streaming into the process at typically a very high rate, the data must be managed as it arrives in a stream. The storage requirements for the data received and the storage capabilities of a typical computing device preclude storage followed by subsequent batch processing. Since the full data set is never seen there are potential errors in determining what is a frequently occurring patterns. The prior art clustering requires consideration of every data element V1, V2, V3, etc. within each data item i, j, k, etc and consideration of each data item sequentially. The process can pick out frequently occurring patterns by a count of patterns seen as the data stream arrives sequentially or can count particular data items by consideration of the data elements within each data item. A typical output of prior art analysis is a tabulation of frequently occurring patterns found within the data 205.

One embodiment of the current invention, by contrast to the prior art, filters a stream of data into queues. The filtering may be based upon a single data item appearing in the data stream, a collection of data items appearing in the data stream, or a collection of data elements appearing in the stream or extrinsic parameters related to the stream. Nonlimiting extrinsic parameters include the source of the data stream, the time of day, etc. The filtering separates the data stream into a collection of data queues. In one embodiment each queue is itself a data stream. The separated queues may then be handled in parallel. In another embodiment the invention includes filtering multiple streams into separate data queues that may be further processed in parallel. The queues represent a collection of data items each containing multiple data elements. The queues are streams of data, that are time varying, that are parsed from the full incoming data stream. The filtering step selects data items that the user has decided should be handled uniquely. In one embodiment the queues do not necessarily represent unique collections of data. Queue i and Queue j may include the same data elements. In one embodiment the current invention filters a stream of incoming data into multiple streams that may be further processed based upon a pre-selected characteristic of each separated stream. In another embodiment the invention includes receiving multiple streams of data and filtering the multiple streams into data queues that may then be analyzed in parallel.

Once the data set is broken into separate queues the current inventive system may then take advantage of parallel processing to handle the multiple data sets. Although the data must be handled as a serial stream since that is the way it is presented to the computing device, once broken up into queues, separate queues may be processed in parallel to speed analysis of the data. In this manner the speed and efficiency of parallel processing is applied to serially streaming data. The present invention includes the idea of parallel processing which may be applied to prior art clustering steps and further includes new means for creating clusters or queues through filtering of the data based upon keys embedded within the data stream. The processing steps 205 include any process that a computing device may be programmed to do to act on a data set represented by a queue 204. Processing steps may be to transform the data for example through statistical analysis calculating means medians and standard deviations. Processing steps may include, for example, calculating trends for particular data elements versus time such as predicting a stock price based upon past performance. Processing steps may include sending communications such as a warning based upon the collective value of a set of data elements. The warning may for example be that a particular weather event is heading towards a particular location or include buy or sell orders as stock prices trend up or down and the volume of transactions trend up or down.

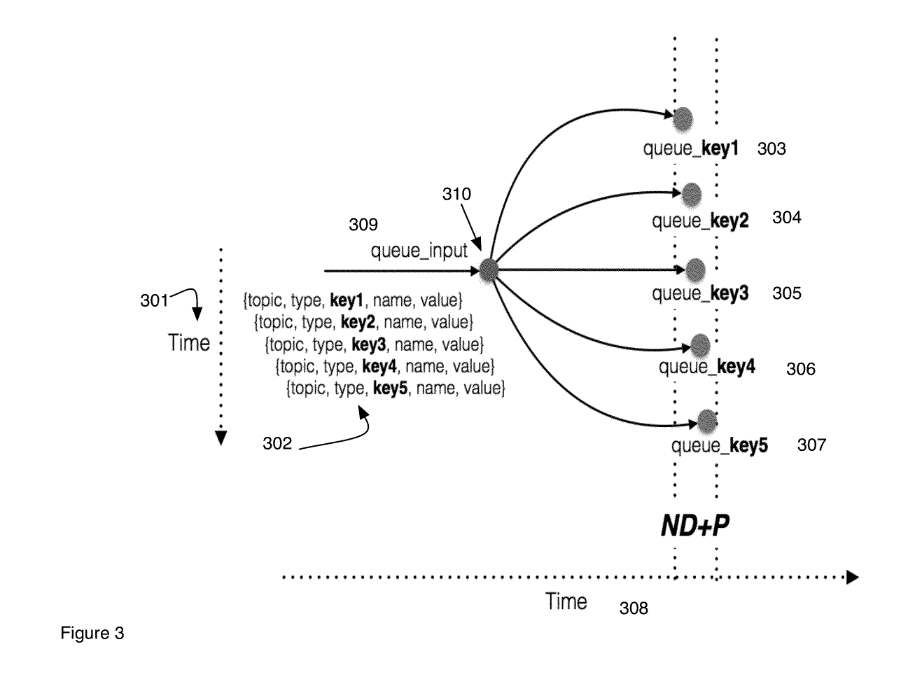

A first embodiment of the present invention is shown in FIG. 3. A stream of data 302 is received 309 over time 301 and then filtered 310 into separate queues 303-307. The data stream is comprised of data items and each data item includes data elements. The data elements in the present example are topic, type, key, name and value. Each data item includes a key here labeled key1, key2, etc. In one embodiment the keys are data elements included in each data items that are pre-selected with vales set in the filter 310 such that the particular key results in splitting the data items containing that key into a particular queue 303-307. In the example shown data items that include the key: key1 are parsed into queue_key1. Those that include key2 are split into queue labeled queue_key2, etc. Note that unlike the prior art shown in FIG. 2, the entire data item need not be examined. Only those data elements selected as keys need be examined to parse or cluster the data into separate queues. In one embodiment the keys are all located in a particular location within each data item. In the case shown the keys are the third data element in each data item. In another embodiment rather than comparing values for the keys, the filter 310 looks only for the existence of the key. In the example shown the location for the key is examined and if present, the associated data stream is placed in a first queue and if absent the data stream is placed in a second queue. In both embodiments there is no need to examine all of the data elements within each data item in order to place the data stream in a particular queue. In this manner the filter process can operate at a much greater speed and use less processor resources than in the prior art examples of FIG. 2. Note that the queues are still time varying 308 and a potentially continuous stream as each represents a stream of data that is split from the input stream 309 that continues to flow.

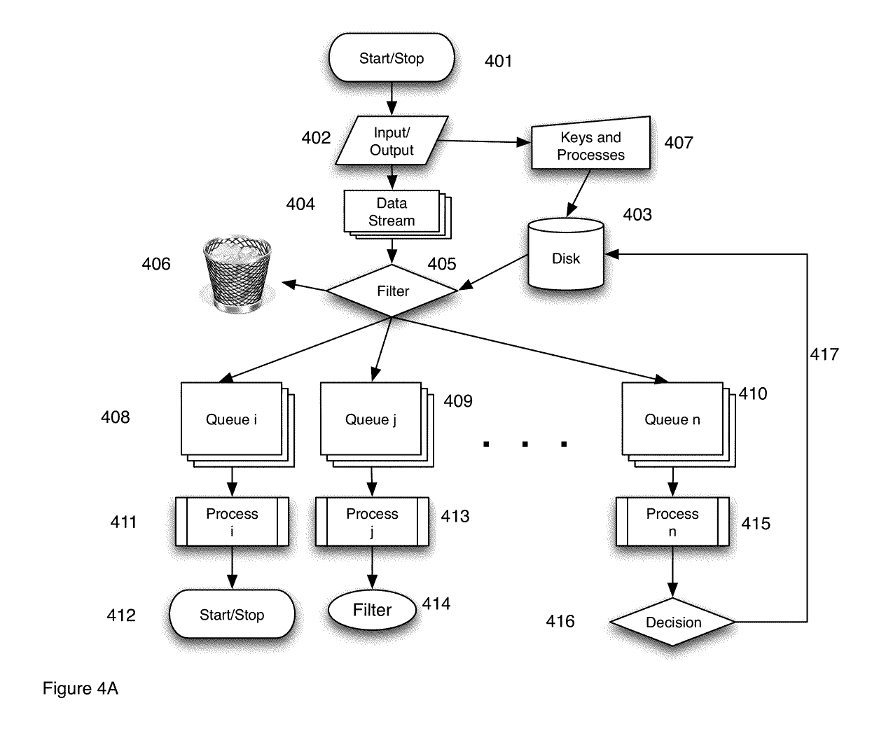

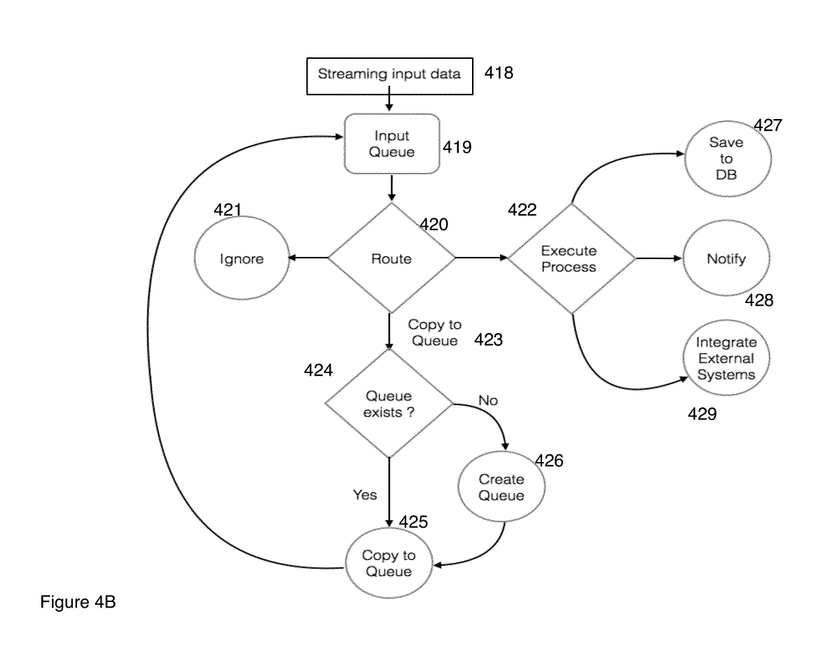

Referring now to FIG. 4A a flow chart of an embodiment of the invention is shown. The process is initiated 401 by a user who inputs 402 data and processing parameters 407 that are stored 403. Non-limiting examples of data and processing parameters include a selection or definition of at least one key and an action to be completed on data streams that include the selected key. A key represents a single data element, a series of data elements, or a collection of data elements anticipated by the user to be within the data items in a data stream. As already discussed, a data stream is a sequence of data items flowing into the input of a computing device. Data items are comprised of data elements. An action to be completed is any action that a computing device may be programmed to take triggered by an input stream. Nonlimiting Actions may include storing data, deleting data, sending messages, sending data to an output port, performing an operation on data including combining data streams, transforming data such as reading data in a particular format and transforming the data to a new format, initiating peripheral devices connected to the computing device. Exemplary peripheral devices include printers, video displays and audio output devices. Once initiated a data stream is received 404 and filtered 405. The filter uses the stored input 403 to separate the data stream into queues 408-410. In one embodiment a portion of the data stream is discarded 406. The discarded data is an equivalent queue to the other queues 408-410 and the process selected is discarding the data. The filter 405 tests for presence of a particular key and on the basis of the presence or absence of a key in the data stream splits data items including the key to different queues 408-410. The initial setup 407 also included particular processing steps 411, 413, 415 that may take place upon receiving data into a particular queue. In one embodiment the processing activity is a single process and then stops 412. In another embodiment the processing 413 may be followed by a second filter step 414. The filter process parameters would be set up at initialization 402, 407 or in another embodiment detection of data in the queue 413 would trigger a new filtering process beginning at 410, 402 etc. In one embodiment the process step 413 is a transformation of the data within the data stream of the queue and the transformation creates new keys to be used in the filter 414. In one embodiment the process 413 is a data mining step for frequently occurring patterns and new keys are defined for frequently occurring patterns. The third exemplary processing 410 of queues is similar to the sequence 409, 413, 414. The process 415 looks at data and then a decision step is made on the basis of the data stream within the queue 410 to loop back 417 and record new data and/or processing parameters to be stored 403 and used for filtering 405 the data stream for subsequent data.

Another embodiment of the invention is shown in the flow chart of FIG. 4B. Streaming data 418 is input to the system input queue 419. The inventive system routes 420 the data stream according to pre-selected parameters. Pre-selected parameters may include particular keys found in the data stream.

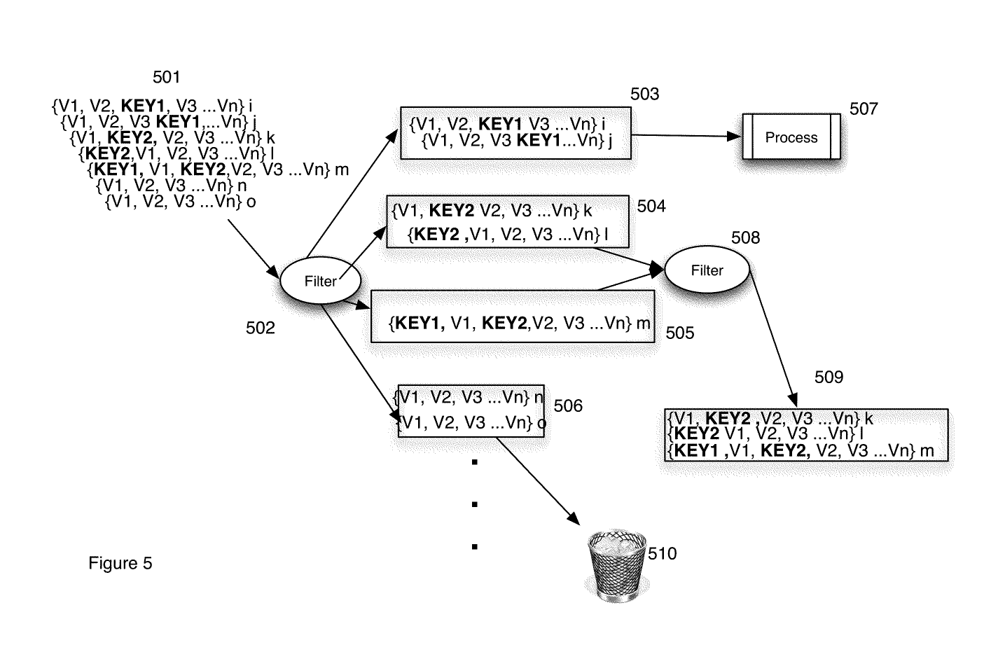

Keys may include data items within a stream, data elements within a stream, the source of a data stream or context surrounding receipt of the data stream such as the time of day, weather, attendance at an event, contents of a second data stream, existence of a second data stream or any other external or internal to the data stream actual or contextual elements. The data stream is routed 420 based upon pre-selected parameters to either ignore the data stream 421, execute a process 422 or copy to a queue 423. Copying to a queue will first test that the queue exists 424 and if so stream the data to the queue 425 and continue to monitor the input queue 419. If the queue does not exist a queue is created 426 and the stream is then copied to the newly created queue 425 and the input stream is continuously monitored 419. Nonlimiting examples of the execute process step include copying data to a database 427, creating a notification 428, and integrating external systems 429. Copying the data to a database may include storing the data stream for further manipulation later or continuously as data arrives. Notification 428 may include alerting a user or a group of user of content of a data stream of that an event has occurred that triggered creating a new queue. Integrating external systems includes accessing additional resources for either filtering the data or for other computations to happen in parallel as the data stream is continuously received 418. The invented system creates queues through dynamic filtering and portioning of the incoming data streams. In one embodiment the system aggregates data streams from disparate sources in order to correlate otherwise unrelated data in real time. Having a networked system through the Internet or any other network allows access to multiple streams for splitting data streams into separate queues and combining incoming data streams into new queues for processing, storage and analysis. A Nonlimiting exemplary uses of such a system includes correlation between user system performance and performance deterioration and modifications of system configurations either intentional or through rogue actions. User experience can be in web applications or any other applications using the system(s) associated with accessible data streams. A second nonlimiting exemplary use includes correlation of new product sales number to social media chatter preceding the new product's introduction. A third exemplary use is prediction of sports or other event attendance based upon correlating stream data related to internet chatter related to the event, weather, team records, traffic patterns and city demographics. Another embodiment of the invention is shown in FIG. 5. Here an incoming data stream 501 includes data items i through o and each data item includes multiple data elements. Some of the data items include keys and some do not. For exemplary purposes only two keys are shown but the embodiment implies more generally to effectively infinite data sets and a plurality of keys. The data stream is filtered 502 and the filtering results in a plurality of queues 503-506. The filter process includes looking for the keys key1 and key2 and taking actions on the basis of their presence or absence. In the current example data elements that include just key1 are filtered into a queue 503 and processed 507 according to a preselected process 507. Those data items that contain key2 are filtered into a second queue 504 and those that contain both keys 1 and 2 are filtered into a third queue 505. The second and third queues are further filtered 508 and in this example are recombined into a new queue 509. Those data items in the input queue 501 that contain neither key1 nor key2 are filtered into a queue 506 and in this example discarded 510. The embodiment shows that the filtering may be on the basis of a single key within the data items of a data stream and multiple keys within the data items and actions can be tailored on the basis of the particular keys present and the presence of multiple keys. Actions can also be taken on the basis of absence of keys within the data items. In the example the data items with no keys are discarded 510, but the process 510 for data items not including keys can be any data process for which the computing device may be programmed.

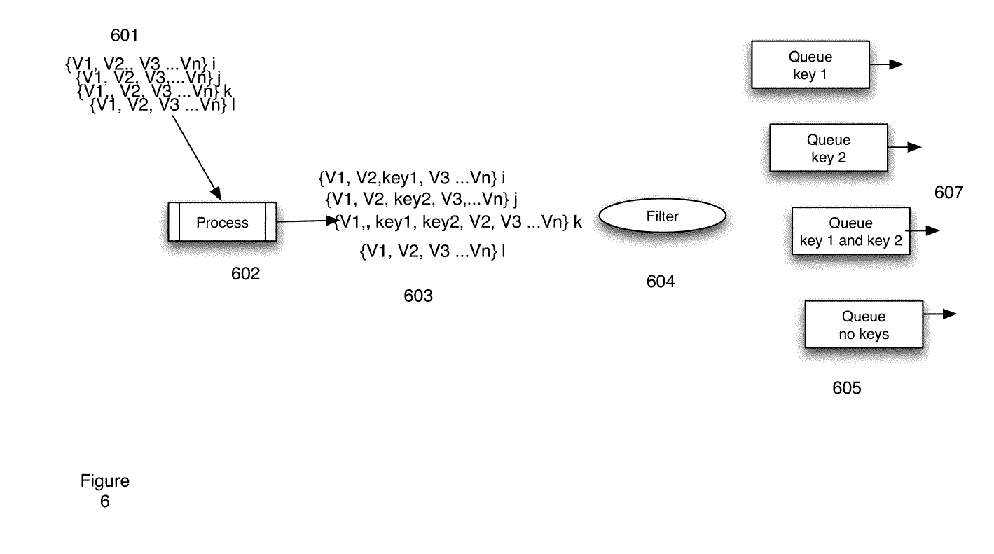

Another embodiment of the invention is shown in FIG. 6. A data stream 601 is input into a computing device. In this case however there are no keys inherent in the data stream. The process further includes a processing step 602 that pre-process the data and creates keys based upon the data observed. In the exemplary instant case a data stream is comprised of data items i through data item 1. The process step 602 creates a set of keys, here just key1 and key2 from examination of the data elements in each data item. The process then inserts the keys into the data stream producing a new data stream 603 that is an equivalent data stream over time as the input stream 601 except that it now further includes keys as data elements within the data items the process continues as already discussed where the data now containing keys may be filtered 604. The result is a set of data queues 605 that are subsequently processed in parallel 607. In one embodiment the process 602 to create the keys is done on a first processor and the process of filtering 604 is done on a second processor. In this manner the first process 602 that requires more processing power may be done a processor with speed and memory to handle such processing and the data is then prepared such that filtering may be accomplished on a second processor such as a microprocessor. In one embodiment the first process 602 takes place on a server and the second process 604 takes place on a personal computer or portable computing device such as a tablet or cellular telephone.

### SUMMARY

A real time data analysis and data filtering system for managing streaming data is presented. The method breaks a stream of data into a set of queues that are themselves streaming data but that are handled separately by unique processing steps. The queues are dynamically created on an as needed basis based on inspection of the data. In this manner the speed and efficiency of parallel processing is applied to serially streaming data. Furthermore, the separation of a single data stream into multiple parallel streams enables clear thought process for creating or defining independent pattern handling logic for each individual sub-stream as compared to the complexity of processing a single stream in its entirety. A method of filtering the data to present the new streaming data queues is also described. The method makes use of keys that are used to filter the data stream into individual queues. In another embodiment a pre-processing step includes creation of keys and insertion of keys into the streaming data to enable subsequent data mining to be accomplished on a less powerful computing device. Those skilled in the art will appreciate that various adaptations and modifications of the preferred embodiments can be configured without departing from the scope and spirit of the invention. Therefore, it is to be understood that the invention may be practiced other than as specifically described herein, within the scope of the appended claims.

What is claimed is:

1. A method for managing a data stream said method comprising:
a) programming a computing device having a memory, to receive an input data stream from a data source said data stream comprising data items presented serially over time and said data items including data elements,
b) programming the computing device to store at least one selected key in the memory of the computing device where the selected key is a possible value for a data element,
c) programming the computing device to filter the data stream into separate queues based upon the occurrence of the at least one selected key within a data item, wherein the queues are themselves data streams,
d) storing at least one pre-selected action to be performed by the computing device on an at least one pre-selected separated queue,
e) performing the pre-selected action on the at least one pre-selected separated queue.

2. The method of claim 1, further comprising storing a plurality of programs for the computing device to perform, said programs comprising pre-selected processing steps to be completed when values for particular keys are encountered in the input data stream, and, programming the computing device to run the pre-selected processing steps on the separated queues in parallel while continuing to receive input data.

3. The method of claim 2 wherein the pre-selected processing step includes inserting a new data element into at least one data item of at least one separated queue.

4. A method for managing a data stream said method comprising:
a) programming a computing device having a memory, to receive an input data stream from a data source said data stream comprising data items presented serially over time and said data items including data elements,
b) programming the computing device to store at least one selected key in the memory of the computing device where the selected key is a possible value for a data element,
c) programming the computing device to filter the data stream into separate queues wherein the queues are themselves data streams and wherein the filtering is done on the basis of at least one of a: stored pre-selected values for particular data elements observed in the data elements, the source of the data stream, the time of day, multiple occurrences of a data element observed in the data stream,
d) storing at least one pre-selected action to be performed by the computing device on an at least one pre-selected separated queue,
e) performing the pre-selected action on the at least one pre-selected separated queue.

5. The method of claim 4 wherein the pre-selected action includes inserting a new data element into at least one data item of at least one separated queue.

6. The method of claim 4, further comprising storing a plurality of programs for the computing device to perform pre-selected processing steps to be completed when values for particular keys are encountered in the input data stream, and, programming the computing device to run the pre-selected processing steps on the separated queues in parallel while continuing to receive input data.

7. The method of claim 6 wherein the pre-selected processing step includes inserting a new data element into at least one data item of at least one separated queue.
